(19) United States
(12) Patent Application Publication
(10) Pub. No.: US 2026/0163844 A1
(43) Pub. Date: Jun. 11, 2026

(54) QUEUE IDENTIFIERS FOR TRANSMISSION OF NETWORK FLOWS

(71) Applicant: Juniper Networks, Inc., Sunnyvale, CA (US)

(72) Inventors: Michael HENKEL, Saratoga, CA (US); Vikram SINGH, San Jose, CA (US); Michal STYSZYNSKI, Antony (FR); Ariel COHEN, Cupertino, CA (US)

(21) Appl. No.: 18/971,972

(22) Filed: Dec. 6, 2024

(51) Int. Cl. H04L 47/62

(52) U.S. Cl. CPC H04L 47/621

(57) ABSTRACT

In some implementations, a device may communicate queue pair establishment information associated with a plurality of queue pairs of a sender endpoint and a receiver endpoint. The device may communicate memory partitioning information that associates a plurality of memory region partitions with respective queue pairs of the plurality of queue pairs. The device may assign a plurality of queue identifiers to the respective queue pairs. The device may associate the plurality of queue identifiers with respective egress links of the device. The device may transmit based on the plurality of queue identifiers, a plurality of network flows via the respective egress links.

### BACKGROUND

Large language models (LLMs) are trained using multiple graphics processing units (GPUs), as the memory capacity of a single GPU is insufficient to accommodate an entire LLM. For example, an artificial intelligence or machine learning (AI/ML) training cluster can include hundreds or even thousands of GPUs. Because a server in an AI/ML training cluster hosts a limited quantity of GPUs (e.g., eight GPUs), multiple servers can be employed to train an LLM. During LLM training, each GPU synchronizes a local memory with one or more local memories of other GPUs (e.g., GPUs hosted by other servers), which requires extensive data transfer across the network connecting all of the GPUs. This synchronization generates sustained, high-bandwidth traffic bursts on the network.

### SUMMARY

Some implementations described herein relate to a method. The method may include communicating, by a device, queue pair establishment information associated with a plurality of queue pairs of a sender endpoint and a receiver endpoint. The method may include communicating, by the device, memory partitioning information that associates a plurality of memory region partitions with respective queue pairs of the plurality of queue pairs. The method may include assigning, by the device, a plurality of queue identifiers to the respective queue pairs. The method may include associating, by the device, the plurality of queue identifiers with respective egress links of the device. The method may include transmitting, by the device, based on the plurality of queue identifiers, a plurality of network flows via the respective egress links.

Some implementations described herein relate to a device. The device may include one or more memories and one or more processors. The one or more processors may be configured to communicate queue pair establishment information associated with a plurality of queue pairs of a sender endpoint and a receiver endpoint. The one or more processors may be configured to communicate memory partitioning information that associates a plurality of memory region partitions with respective queue pairs of the plurality of queue pairs. The one or more processors may be configured to assign a plurality of queue identifiers to the respective queue pairs. The one or more processors may be configured to associate the plurality of queue identifiers with respective egress links of the device. The one or more processors may be configured to transmit, based on the plurality of queue identifiers, a plurality of remote direct memory access (RDMA) network flows via the respective egress links.

Some implementations described herein relate to a non-transitory computer-readable medium that stores a set of instructions. The set of instructions, when executed by one or more processors of a device, may cause the device to communicate queue pair establishment information associated with a plurality of queue pairs of a sender endpoint and a receiver endpoint. The set of instructions, when executed by one or more processors of the device, may cause the device to communicate memory partitioning information that associates a plurality of memory region partitions with respective queue pairs of the plurality of queue pairs. The set of instructions, when executed by one or more processors of the device, may cause the device to assign a plurality of internet protocol (IP) addresses to the respective queue pairs. The set of instructions, when executed by one or more processors of the device, may cause the device to associate the plurality of IP addresses with respective egress links of the device. The set of instructions, when executed by one or more processors of the device, may cause the device to transmit, based on the plurality of IP addresses, a plurality of network flows via the respective egress links.

### BRIEF DESCRIPTION OF THE DRAWINGS

FIGS. 1A-1E are diagrams of an example implementation associated with queue identifiers for transmission of network flows.

FIG. 2 is a diagram of an example implementation associated with memory region partitioning.

FIG. 3 is a diagram of an example implementation associated with route-based deterministic flow pinning.

FIG. 4 is a diagram of an example implementation associated with handling leaf-to-spine link errors.

FIG. 5 is a diagram of an example environment in which systems and/or methods described herein may be implemented.

FIG. 6 is a diagram of example components of a device associated with queue identifiers for transmission of network flows.

FIG. 7 is a diagram of example components of a device associated with queue identifiers for transmission of network flows.

FIG. 8 is a flowchart of an example process associated with queue identifiers for transmission of network flows.

### DETAILED DESCRIPTION

The following detailed description of example implementations refers to the accompanying drawings. The same reference numbers in different drawings may identify the same or similar elements.

GPUs in AI/ML training clusters are often interconnected using an Ethernet-based Clos fabric, such as a three-stage Clos fabric topology configured in a one-to-one subscription mode. For example, the quantity of nodes (e.g., GPUs) connected to each leaf node (e.g., leaf switch) may equal the total quantity of spine nodes (e.g., spine switches). This topology may help to enable the ingress-leaf-to-spine links and spine-to-egress-leaf links to provide equal available bandwidth to all nodes within a given stage of the Clos fabric. However, in this topology, simultaneous connections between four nodes can result in a blocked path for the remaining four nodes. Clos theory stipulates that for a network to be strictly non-blocking, connections must be rearrangeable. This rearrangement may occur at one or more ingress leaf nodes using state information from all spine nodes.

AI/ML training applications typically rely on the RDMA protocol to transfer GPU memory across networks. RDMA was originally designed for InfiniBand-based networks, which are inherently lossless and ensure in-order packet delivery. Consequently, RDMA is highly sensitive to packet loss or out-of-order delivery. Thus, for optimal performance, a network utilized in an AI/ML training cluster may provide lossless operation and in-order packet delivery. However, unlike InfiniBand, Ethernet is inherently a lossy protocol and does not guarantee in-order packet delivery. Rather, Ethernet offloads responsibility for reliable packet delivery to upper layer protocols (ULPs), which implement mechanisms such as retransmission and congestion control.

The RDMA over converged Ethernet version 2(ROCEv2) protocol may facilitate RDMA over Ethernet networks. ROCEv2 transports RDMA packets over Ethernet by encapsulating the RDMA packets within a user datagram protocol (UDP) header. However, UDP is a stateless protocol that lacks congestion control and does not support retransmission of lost packets. Congestion in an AI/ML training cluster can increase job completion time, which can ultimately delay training of LLMs and use excessive processing and/or memory resources.

As a result, the requirements for lossless operation and in-order packet delivery present at least two challenges for AI/ML training applications running on Ethernet networks. The first challenge relates to ingress leaf egress link selection. For example, flows entering an ingress leaf node may encounter multiple equal egress paths. For example, in a two-by-two topology, the ingress leaf node may select one of two equivalent egress links to transmit a flow. The ingress leaf node may determine an appropriate egress link for each flow originating from a connected node (e.g., a GPU). Probabilistic approaches for selecting an optimal ingress leaf egress link for a flow, such as static hashing, dynamic load balancing (DLB), and reactive path rebalancing (RPR), can lead to congestion, lost packets, and/or out-of-order packet delivery.

Static hashing may involve hashing incoming flows using a five-tuple of layer 3(L3) and layer 4(L4) parameters. For example, the five-tuple may include a source IP address, a destination IP address, a source port, a destination port, and a protocol of the flow. The resulting hash may determine to which egress link the flow is assigned. Static hashing tends to perform well in examples involving many small flows that provide sufficient entropy (because high entropy ensures a more balanced distribution of flows across available links). However, AI/ML training network traffic patterns typically involve a small quantity of large flows, resulting in low entropy. As a result, using static hashing in AI/ML training clusters can cause multiple flows to be assigned to the same egress link, causing contention for bandwidth. The resulting congestion can lead to packet drops, violating the lossless requirement of the network.

DLB offers an alternative method for egress link selection that involves continuously monitoring the quality of all available egress links. Upon introduction of a new flow, DLB may assign the new flow to an egress link with a best current quality. The quality of an egress link may be based on buffer utilization, quantity of queued packets, or the like. However, DLB lacks time granularity. For example, link quality assessments can only occur at specific intervals, such as a maximum frequency of 1 microsecond (ms). However, in a high-performance AI/ML training cluster, multiple flows may arrive at an ingress leaf node within sub-ms intervals. Under such conditions, DLB can cause these flows to be assigned to the same egress link, leading to congestion, thus violating the lossless requirement of the network.

RPR offers a mechanism to relocate active flows to alternative links if a utilization of a current link exceeds a predefined threshold. As a result, RPR can help to alleviate congestion caused by multiple flows being assigned to the same ingress leaf egress link. However, relocating running RDMA flows presents challenges due to the strict in-order packet delivery requirement. For example, moving an active RDMA flow from one link to another can result in a situation where packets remain queued on the original link and are transmitted with a delay, while the new link, having an empty queue, immediately transmits subsequent packets. This sequence of events can cause later packets to arrive at the destination before earlier ones, leading to out-of-order delivery and thereby necessitating retransmission.

The second challenge for AI/ML training applications running on Ethernet networks presented by the requirements for lossless operation and in-order packet delivery relates to spine-to-egress-node blocking. In a Clos network, flows can block paths between a spine node and an egress leaf node, which can prevent other flows from accessing those paths. Such blockages may be mitigated by rearranging active flows at the ingress leaf node, but rearranging RDMA flows is not feasible without risking out-of-order packet delivery. Moreover, the ingress leaf node rearranges active flows using the state of flows across all spine nodes. Evaluating these states at the spine nodes, communicating the evaluation from the spine nodes to the ingress leaf node, and calculating the resulting actions at the ingress leaf node consumes excessive time, processing, and/or memory resources due to the continuously changing state of the network. For example, by the time the rearrangement is complete, the state may have already changed, rendering the action ineffective. Although global load balancing (GLB) can be implemented to enhance existing load-balancing mechanisms by allowing upstream switches to provide state information to downstream switches, and the downstream switches can use the state information to make informed egress link selections, GLB does not address scenarios where an existing flow already blocks a path between a spine node and an egress leaf node.

Some implementations described herein enable deterministic link selection for flow placement. In some aspects, an ingress leaf node may assist in decomposing large flows into smaller flows (e.g., sub-flows). For example, a large flow may be divided into a quantity of sub-flows that is equal to a quantity of ingress leaf egress links. In some aspects, the ingress leaf node may assist in partitioning memory of a GPU. For example, memory may be divided into segments assigned to respective sub-flows. In some aspects, the ingress leaf node may assign (e.g., allocate) unique and deterministic identifiers to respective sub-flows. In some aspects, the ingress leaf node may pin the sub-flows to respective ingress leaf egress links by assigning each sub-flow to a specific ingress leaf egress link based on a corresponding unique and deterministic identifier. In some aspects, the ingress leaf node may transmit all sub-flows concurrently such that the bandwidth consumed by each sub-flow is proportional to a total flow bandwidth divided by a quantity of ingress leaf egress links.

As a result, AI/ML models may be trained over networks that support lossless operation and in-order packet delivery. For example, decomposing the large flows into smaller flows may help to increase entropy and improve load distribution across the network, and an ingress leaf node may select an egress link for a (smaller) flow that is deterministically pinned to that egress link. Thus, the ingress leaf node may prevent spine-to-egress-leaf blocking without rearranging RDMA flows or receiving and analyzing the states of various flows across all spines. Therefore, deterministically selecting links for flow placement can help to ensure in-order packet delivery, mitigate congestion (thereby supporting lossless operation), reduce consumption of time, memory, and/or processing resources, or the like.

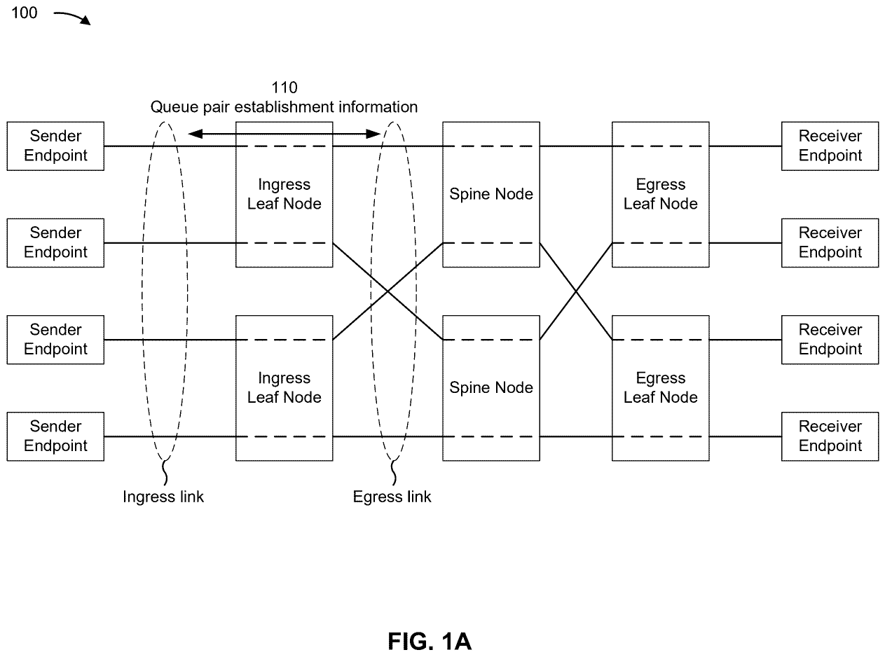

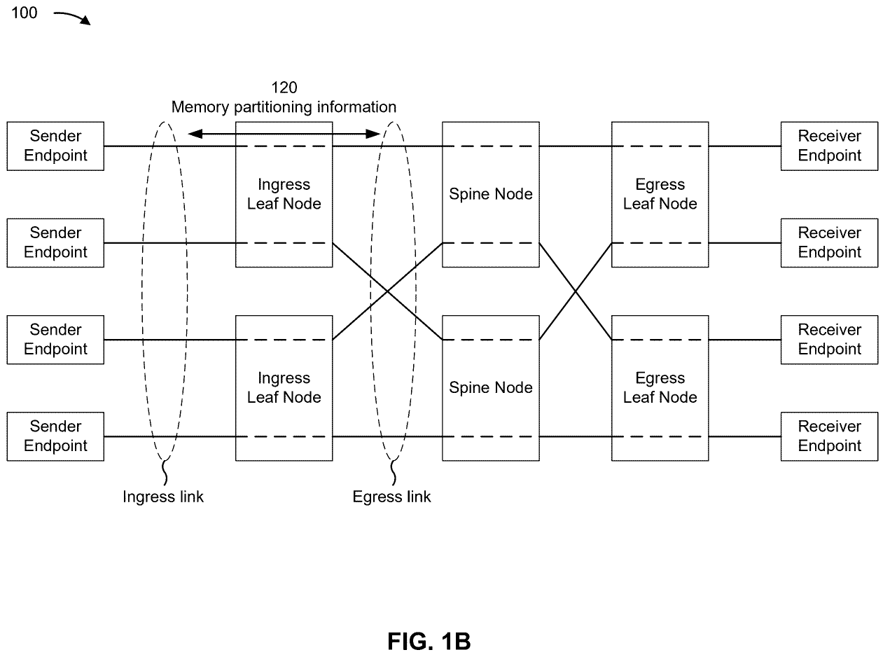

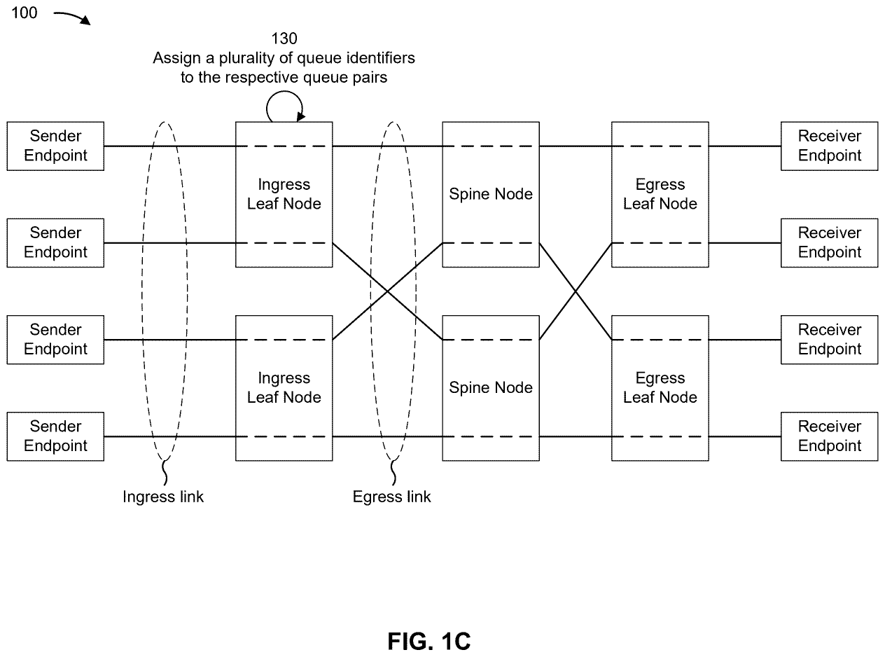

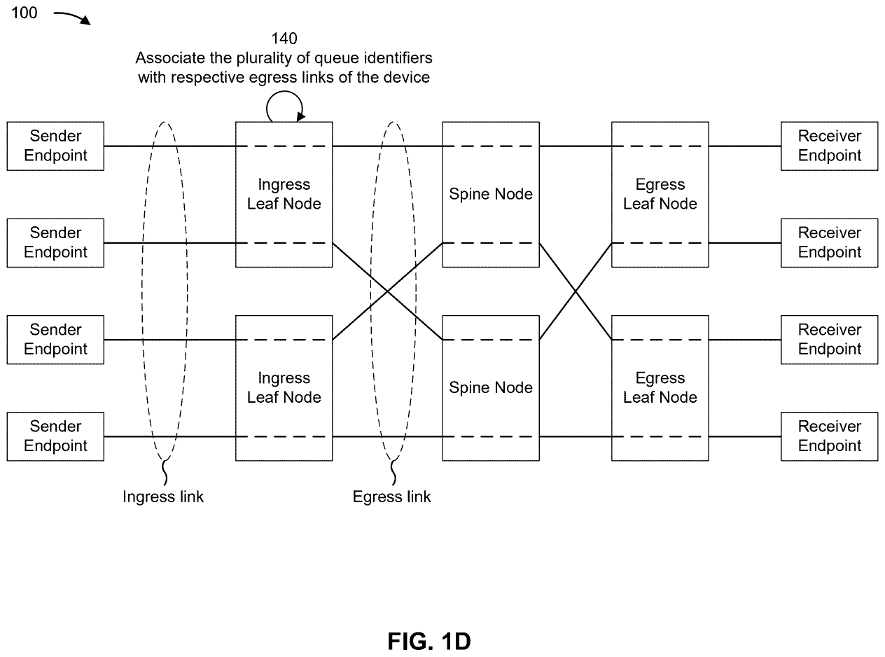

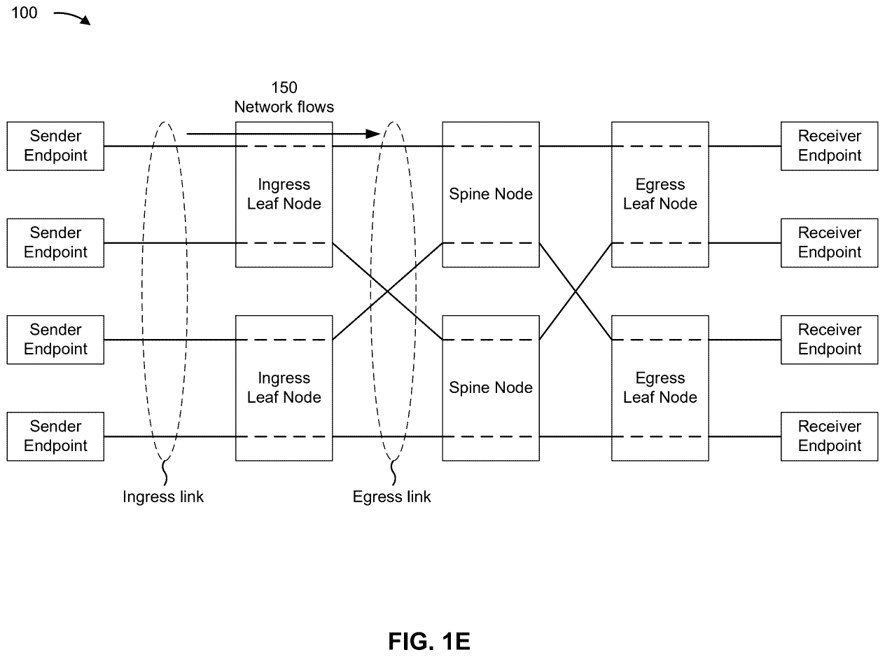

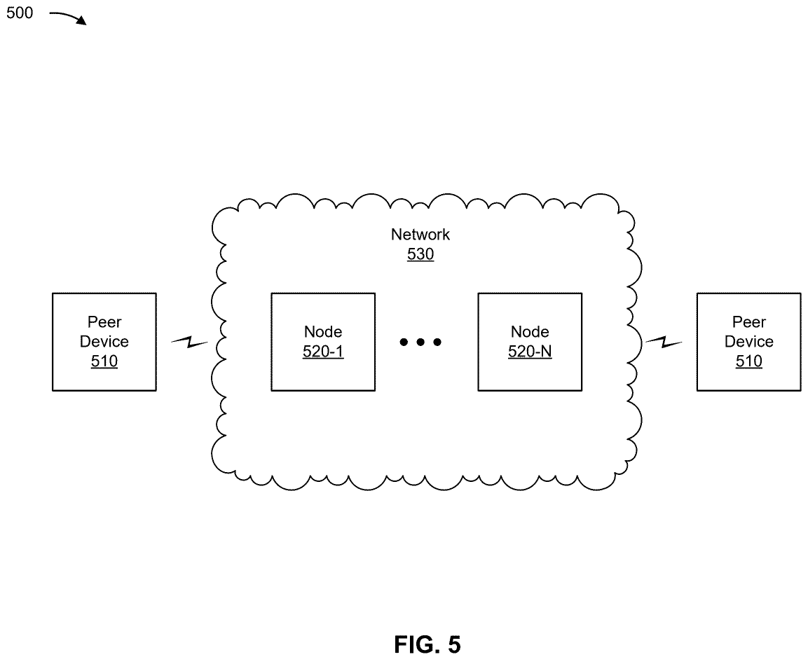

FIGS. 1A-1E are diagrams of an example implementation 100 associated with queue identifiers for transmission of network flows. As shown in FIGS. 1A-1E, example implementation 100 includes sender endpoints, ingress leaf nodes, spine nodes, egress leaf nodes, and receiver endpoints. These devices are described in more detail below in connection with FIGS. 5-7.

With reference to FIG. 1A, as shown by reference 110, an ingress leaf node may communicate queue pair establishment information associated with a plurality of queue pairs of a sender endpoint and a receiver endpoint. For example, the sender endpoint (e.g., a first GPU) may store data that is to be transmitted to the receiver endpoint (e.g., a second GPU). The plurality of queue pairs may include a plurality of send queues (at the sender endpoint) connected to respective receive queues (at the receiver endpoint). The queue pair establishment information may be associated with the plurality of queue pairs in that the queue pair establishment information may include information exchanged by the sender endpoint and the receiver endpoint that enables the sender endpoint and the receiver endpoint to establish the plurality of queue pairs.

For example, in RDMA, a single queue pair may establish a connection between the sender endpoint and the receiver endpoint for data transmission. The sender endpoint may be designated as an active sender, and the receiver endpoint may be designated as a passive receiver, with the sender endpoint initiating queue pair creation. In some examples, the sender endpoint may create and/or configure a send queue based on information received from the receiver endpoint, and/or the receiver endpoint may create and/or configure a receive queue based on information received from the sender endpoint. The sender endpoint and the receiver endpoint may connect the send queue and the receive queue to form a queue pair.

Queue pair creation may occur in phases, including an initial phase, an information exchange phase, and a ready to send (RTS) or ready to receive (RTR) phase. In the initial phase, the sender endpoint and the receiver endpoint may create the send queue and the receive queue, respectively, and set the queues to an initial state. During the initial phase, the sender endpoint and the receiver endpoint interface may select respective interfaces for, and assign respective random queue pair number (QPNs) to, the queue pair.

In the information exchange phase, the sender endpoint may transmit the sender QPN and address information corresponding to the sender interface to the receiver endpoint. Using this information, the receiver endpoint may determine an appropriate receiver interface and respond with the receiver QPN and address information corresponding to the receiver interface. The sender QPN may serve as a destination QPN for the receiver endpoint, and receiver QPN may serve as a destination QPN for the sender endpoint. This information exchange may occur over a control channel that is not provided by RDMA, such as a transmission control protocol (TCP) socket, gRPC remote procedure calls (gRPC), or the like. In some examples, a QPN may be carried in a base transport header (BTH). In some examples, the queue pair establishment information may include the sender QPN, the address information corresponding to the sender interface, the receiver QPN, and/or the address information corresponding to the receiver interface. In some examples, the queue pair establishment information may be carried via the control channel.

In the RTS or RTR phase, the sender endpoint may transition the send queue to the RTS state, and the receive endpoint may transition the receive queue to the RTR state. A random UDP source port may be assigned to each queue pair during the RTS or RTR phase, thereby completing the connection between the send queue and the receive queue. In some examples, the random UDP source port may be carried in the UDP header.

RDMA may support the creation of the plurality of queue pairs between the sender endpoint and the receiver endpoint. For example, the sender endpoint and the receiver endpoint may repeat the initial phase, the information exchange phase, and the RTS or RTR phase to create the plurality of queue pairs. For example, the queue pair establishment information may include a plurality of sender QPNs of the plurality of queue pairs, address information corresponding to a plurality of sender interfaces for the plurality of queue pairs, a plurality of receiver QPNs of the plurality of queue pairs, and/or address information corresponding to plurality of receiver interfaces for the plurality of queue pairs. Each queue pair of the plurality of queue pairs may be assigned a distinct QPN and UDP source port. Communication using different queue pairs of the plurality of queue pairs may be treated as respective network flows on the network. In some examples, a quantity of the plurality of queue pairs may be equal to a quantity of ingress leaf egress links (e.g., egress links of the ingress leaf node).

With reference to FIG. 1B, as shown by reference 120, the ingress leaf node may communicate memory partitioning information that associates a plurality of memory region partitions with respective queue pairs of the plurality of queue pairs. The memory partitioning information may associate the plurality of memory region partitions with the respective queue pairs in that the memory partitioning information may assign, to each of the respective queue pairs, a given memory region partition. For example, data stored in a memory region partition assigned to a queue pair may be transmitted from a send queue of the queue pair to a receive queue of the queue pair.

For example, in RDMA, a memory location designated for transfer may be registered as memory region. Each memory region may be associated with a protection domain, and any queue pair within a protection domain can access all memory regions associated with the protection domain. When data stored in a memory region is to be transferred, a queue pair may be selected and configured with memory address(es) of the memory region and length of the data to be transferred. As a result, each queue pair may transmit data stored in a different partition of the memory region, and each partition may operate over an independent flow. Because packets across different flows are permitted to arrive out of order, data stored in different memory region partitions may be transmitted out of sequence. Packets within a single flow may maintain in-order delivery.

With reference to FIG. 1C, as shown by reference 130, the ingress leaf node may assign a plurality of queue identifiers to the respective queue pairs. A queue identifier may represent a source queue of a of a queue pair, a receive queue of a queue pair, and/or a queue pair. Thus, the ingress leaf node may use the queue identifiers to deterministically distinguish individual queue pairs among the plurality of queue pairs. For example, unlike random UDP source ports or QPNs, which allow individual flows to be distinguished on the network and can be used for hashing and load-balancing but are randomly assigned and lack determinism, the queue identifiers may enable the ingress leaf node to deterministically identify a flow and thereby transmit the flow over an appropriate ingress leaf egress link. In some examples, a queue identifier may be carried in a packet header, such as an IP header, a UDP header, a BTH header, or the like.

In some aspects, the plurality of queue identifiers may be a plurality of IP addresses. For example, one IP address may be assigned to each send queue and to each receive queue. The IP addresses may be IP version 4(IPv4) addresses, IP version 6 (IPv6) addresses, or the like. IPv6 may provide a larger address space than IPv4 and/or enable stateless address autoconfiguration (SLAAC) for automatic IPv6 address assignment without manual configuration or involving a dynamic host configuration protocol (DHCP) server. In some examples, during queue pair establishment, a network interface card (NIC) may be selected to host a queue pair. Each NIC may maintain a global identifier (GID) table, which may be populated with the IP addresses configured on the NIC. If a NIC has multiple IP addresses (e.g., IPv4 and/or IPv6), then the GID table may include entries for each IP address. RDMA may allow any of these GID entries (e.g., IP addresses) to be used for a queue pair. During the initial phase, each queue pair may be assigned a distinct IP address, provided that a total quantity of IP addresses configured on the NIC is equal to or greater than a quantity of the plurality of queue pairs. The assigned IP address may then be exchanged between the sender endpoint and the receiver endpoint (e.g., the queue pair establishment information may include the IP address). As a result, each flow between a send queue and a receive queue may have a unique set of source IP addresses and destination IP addresses, which may provide a deterministic identifier that can be leveraged by the underlying network.

In some aspects, the plurality of queue identifiers may be one or more of a plurality of flow labels or a plurality of source ports. In some examples, the plurality of queue identifiers may be the plurality of flow labels. A flow label may be carried in an IP header (e.g., an IPv6 header). For example, the flow label may be a 20-bit IPv6 flow label. In some examples, a flow label value may be defined during the queue pair establishment. If the queue pair is associated with an IPv6 address, then the flow label value may be embedded in a flow label field of the IPv6 header. In some examples, the ingress leaf node may parse the IPv6 header to extract the flow label and perform actions (e.g., routing actions) based on the value of the flow label. Additionally, or alternatively, the plurality of queue identifiers may be the plurality of source ports (e.g., UDP source ports). In some examples, the ingress leaf node (e.g., a NIC driver of the ingress leaf node) may use a flow label to derive a source port. If a flow label is defined for the queue pair, then the source port may be deterministic; if no such flow label is defined (e.g., if the plurality of queue identifiers is the plurality of IP addresses), then the source port may be random (e.g., not deterministic).

With reference to FIG. 1D, as shown by reference 140, the ingress leaf node may associate the plurality of queue identifiers with respective egress links. The plurality of queue identifiers may be associated with the respective egress links in that each queue identifier may uniquely correspond to an egress link. For example, the ingress leaf node may assign each queue identifiers to a different egress link. The association of the plurality of queue identifiers with the respective egress links may be referred to as “deterministic flow pinning” because each flow corresponding to a queue identifier may be associated with (or “pinned to”) a given egress link.

In some aspects (e.g., where the plurality of queue identifiers is the plurality of IP addresses), the ingress leaf node may associate the plurality of IP addresses with the respective egress links using a routing configuration. For example, the ingress leaf node may be configured with a total quantity of subnetworks that is equal to a total quantity of egress links of the ingress leaf node, and each subnetwork may correspond to a different spine node. The ingress leaf node may assign an IP address from one of the subnetworks to a send queue or a receive queue. The ingress leaf node may make routing decisions by performing a destination IP address lookup for a destination IP address indicated in one or more packets received from a send queue. Association of the plurality of IP addresses with the respective egress links using the routing configuration may be referred to as “routing-based pinning.”

In some aspects (e.g., where the plurality of queue identifiers is one or more of the plurality of flow labels or the plurality of source ports), the ingress leaf node may associate the one or more of the plurality of flow labels or the plurality of source ports with the respective egress links using an access control list (ACL). For example, the ACL may associate (e.g., map) the flow labels or source ports (e.g., header values) with respective egress link identifiers. The ingress leaf node may identify which egress link is to carry a packet received from a send queue by performing a lookup in the ACL. Association of the plurality of IP addresses with the respective egress links using the ACL may be referred to as “ACL-based pinning.” For example, ACL-based pinning may enable pinning based on UDP source ports and/or flow labels. Regardless of whether ACL-based pinning or routing-based pinning are used, the resulting traffic pattern may be the same.

With reference to FIG. 1E, as shown by reference 150, the ingress leaf node may transmit, based on the plurality of queue identifiers, a plurality of network flows via the respective egress links. In some examples, the network flows may be deterministically identifiable due to the queue identifiers. For example, the ingress leaf node may receive the plurality of network flows from the sender endpoint, determine the queue identifiers of each of the network flows, determine the egress links corresponding to the queue identifiers, and transmit the network flows over the egress links. In some aspects, the plurality of network flows may be a plurality of RDMA network flows. For example, network packets of the network flows may be formatted in accordance with RoCEv2 or any other suitable RDMA network protocol.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

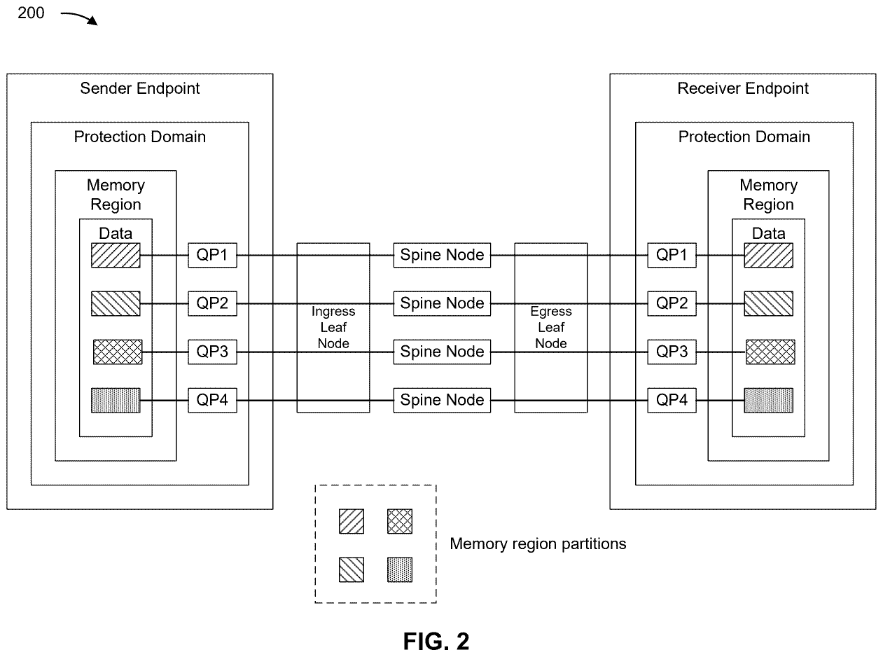

FIG. 2 is a diagram of an example implementation 200 associated with memory region partitioning. As shown in FIG. 2, example implementation 100 includes a sender endpoint (e.g., a first NIC), an ingress leaf node, spine nodes, an egress leaf node, and a receiver endpoint (e.g., a second NIC).

As shown, the sender endpoint and the receiver endpoint may each include a protection domain. The protection domain may include a memory region divided into memory region partitions. Each memory region partition at the sender endpoint includes data (e.g., messages) to be transmitted to a corresponding memory region partition at the receiver endpoint. As further shown, both protection domains include a set of queues. For example, the sender endpoint may include a first send queue, the receiver endpoint may include a first receive queue, and the first send queue and the first receive queue may form a first queue pair (“QP1”); the sender endpoint may include a second send queue, the receiver endpoint may include a second receive queue, and the second send queue and the second receive queue may form a second queue pair (“QP2”); and so forth.

In some examples, the ingress leaf node may receive a plurality of network flows from the sender endpoint. The network flows may carry data from respective memory region partitions and be associated with respective queue pairs. The ingress leaf node may determine queue identifiers of each of the network flows, determine the egress links corresponding to the queue identifiers, and transmit the network flows over the egress links. In this example, a total quantity of queue pairs (e.g., four) equals a total quantity of spine nodes (e.g., four). Thus, the ingress leaf node may transmit the network flows to respective spine nodes. The receiver endpoint may receive the network flows from the spine nodes (via the egress leaf node) and store the data in memory region partitions such that the data storage mirrors data storage in the memory region partitions at the sender endpoint.

As indicated above, FIG. 2 is provided as an example. Other examples may differ from what is described with regard to FIG. 2.

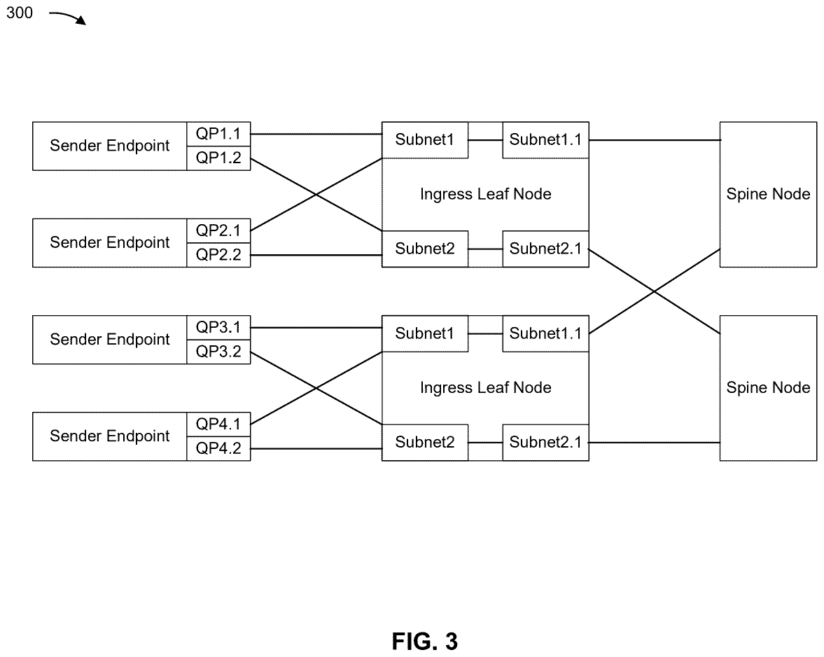

FIG. 3 is a diagram of an example implementation 300 associated with route-based deterministic flow pinning. As shown in FIG. 3, example implementation 300 includes sender endpoints, ingress leaf nodes, and spine nodes.

Each ingress leaf node has two egress links, each configured with one subnetwork and connected to a different spine node. Each sender endpoint may establish two queue pairs (e.g., “QP1.1,” “QP1.2,” “QP2.1,” and so forth). QP1.1, QP2.1, QP3.1, and QP4.1 may be assigned an IP address from a first subnetwork, and QP1.2, QP2.2, QP3.2, and QP4.2 may be assigned an IP address from a second subnetwork. Queue pairs associated with paths through a first spine node (e.g., QP 1.1, QP 2.1, QP 3.1, and QP 4.1) may be referred to as “first-rank” or “rank 1” queue pairs. Queue pairs associated with paths through a second spine node (e.g., QP1.2, QP2.2, QP 3.2, and QP 4.2) may be referred to as “second-rank” or “rank 2” queue pairs. Because each queue pair consumes half of the available bandwidth of an egress link, each egress link has sufficient capacity to handle two queue pairs. When all queue pairs transmit concurrently, the net bandwidth per endpoint equals the total bandwidth of the endpoint.

As indicated above, FIG. 3 is provided as an example. Other examples may differ from what is described with regard to FIG. 3.

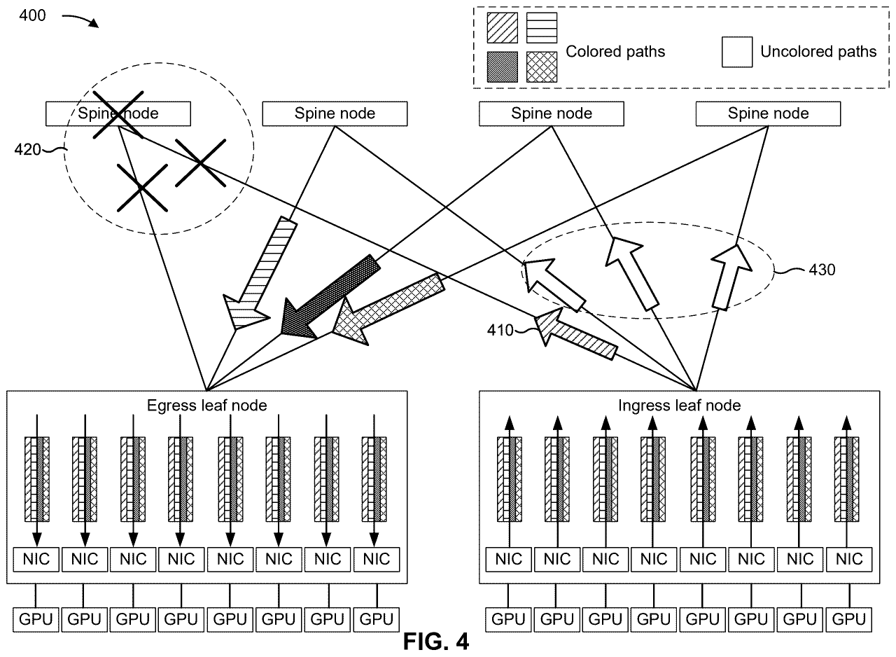

FIG. 4 is a diagram of an example implementation 400 associated with handling leaf-to-spine link errors. As shown in FIG. 4, example implementation 400 includes sender endpoints, an ingress leaf node, spine nodes, an egress leaf node, and receiver endpoints.

As shown by reference number 410, the respective egress links may be included in respective primary paths of the plurality of network flows. A primary path may be a highest-priority path in a network for a given network flow. During a steady state, in which no failures have occurred in the network that would prevent use of the primary path, network flows may be

forwarded via the primary path (e.g., a deterministic primary path). In some examples, the ingress leaf node and the egress leaf node may advertise ranked routes using a dynamic routing protocol, such as border gateway protocol (BGP), to the spine nodes via all available interfaces, and the ranked route having a best metric may be selected as the primary path. For example, routing configurations may be managed using BGP, and individual paths may be colored using BGP color-aware routing (e.g., the primary path may be a colored path).

As shown by reference number 420, the ingress leaf node may detect a failure in a primary path of the respective primary paths. For example, the failure may occur at an ingress node egress link (e.g., the link to which the queue pair is pinned using a deterministic queue identifier), a spine node, an egress node ingress link, or the like. As shown by reference number 430, the ingress leaf node may transmit a network flow of the plurality of network flows associated with the primary path via one or more backup paths. The network flow may be associated with the primary path in that the primary path may be a highest-priority path for the network flow in the network. The one or more backup paths may be backup paths of the primary path. For example, the backup paths may have lower priorities for the network flow than the primary path (e.g., the ranked routes of the backup paths may have lower metrics than the metric of the ranked route of the primary path). In some examples, upon detection of the failure, the network traffic may fall back to the backup paths, which may become active. The backup paths may be defined by configured backup routes (e.g., ranked routes), such as uncolored routes. For example, the ingress leaf node may use BGP multipath routing and leverage DLB and/or GLB for equal cost multi-path (ECMP) decision-making. For example, if all of the backup routes have equal costs, then the ingress leaf node may distribute network traffic for the impacted queue pair across the non-impacted ingress leaf egress links and spine nodes. As a result, the effects of the failure may be distributed across all three backup paths and spine nodes (e.g., instead of sending all of the network traffic over a single ingress leaf egress link to a single spine node). In some examples, congestion may be further controlled using data center quantized congestion notifications (DCQCN).

As indicated above, FIG. 4 is provided as an example. Other examples may differ from what is described with regard to FIG. 4.

Transmitting the plurality of network flows via the respective egress links based on the plurality of queue identifiers may enable AI/ML models to be trained over networks that support lossless operation and in-order packet delivery. For example, the plurality of queue identifiers may provide increased entropy and improved load distribution across the network, and the ingress leaf node may select an egress link for a network flow that is deterministically pinned to that egress link. Thus, the ingress leaf node may prevent spine-to-egress-leaf blocking without rearranging RDMA flows or necessarily requiring the states of various flows across all spines. Therefore, plurality of queue identifiers can help to ensure in-order packet delivery, mitigate congestion (thereby supporting lossless operation), reduce consumption of time, memory, and/or processing resources, or the like.

FIG. 5 is a diagram of an example environment 500 in which systems and/or methods described herein may be implemented. As shown in FIG. 5, environment 500 may include one or more peer devices 510, a group of nodes 520 (shown as node 520-1 through node 520-N), and a network 530. Devices of environment 500 may interconnect via wired connections, wireless connections, or a combination of wired and wireless connections.

Peer device 510 includes one or more devices capable of receiving and/or providing network traffic. For example, peer device 510 may include a traffic transfer device, such as a router, a gateway, a switch, a firewall, a hub, a bridge, a reverse proxy, a server (e.g., a proxy server, a server executing a virtual machine, etc.), a security device, an intrusion detection device, a load balancer, or a similar type of device. In some implementations, peer device 510 may include an endpoint device that is a source or a destination for network traffic. For example, peer device 510 may include a computer or a similar type of device. Peer device 510 may receive network traffic from and/or may provide network traffic (e.g., payload packets) to other peer devices 510 via network 530 (e.g., by routing payload packets using node(s) 520 as an intermediary). In some implementations, peer device 510 may include an edge device that is located at an edge of one or more networks. For example, peer device 510 receive network traffic from and/or may provide network traffic (e.g., payload packets) to devices external to network 530.

Node 520 includes one or more devices capable of receiving, processing, storing, routing, and/or providing traffic (e.g., a payload packet, a file, etc.) in a manner described herein. For example, node 520 may include a router, such as a label switching router (LSR), a label edge router (LER), an ingress router, an egress router, a provider router (e.g., a provider edge router, a provider core router, etc.), a virtual router, or another type of router. Additionally, or alternatively, node 520 may include a gateway, a switch, a firewall, a hub, a bridge, a reverse proxy, a server (e.g., a proxy server, a cloud server, a data center server, etc.), a load balancer, and/or a similar device.

In some implementations, node 520 may be a physical device implemented within a housing, such as a chassis. In some implementations, node 520 may be a virtual device implemented by one or more computer devices of a cloud computing environment or a data center.

In some implementations, node 520 may be configured with one or more segment translation tables. In some implementations, node 520 may receive a payload packet from peer device 510. In some implementations, node 520 may encapsulate the payload packet using a compressed routing header (CRH) and may route the IP payload packet to another node 520, using one or more techniques described elsewhere herein. In some implementations, node 520 may be an edge node in network 530. In some implementations, node 520 may be an intermediary node in network 530 (i.e., a node between two or more edge nodes).

Network 530 includes one or more wired and/or wireless networks. For example, network 530 may include a cellular network (e.g., a fifth generation (5G) network, a fourth generation (4G) network, such as a long-term evolution (LTE) network, a third generation (3G) network, a code division multiple access (CDMA) network, a public land mobile network (PLMN)), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 5 are provided as one or more examples. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

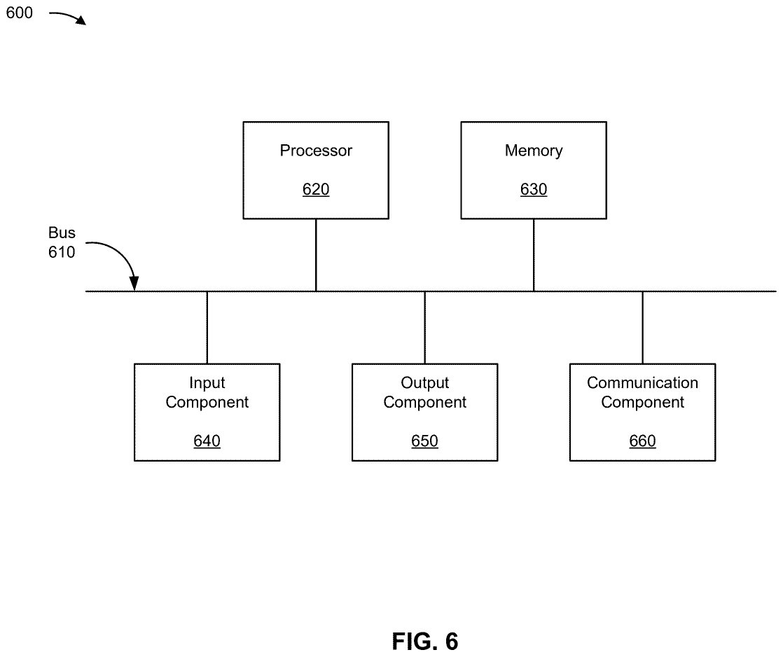

FIG. 6 is a diagram of example components of a device 600 associated with queue identifiers for transmission of network flows. The device 600 may correspond to peer device 510 and/or node 520. In some implementations, peer device 510 and/or node 520 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

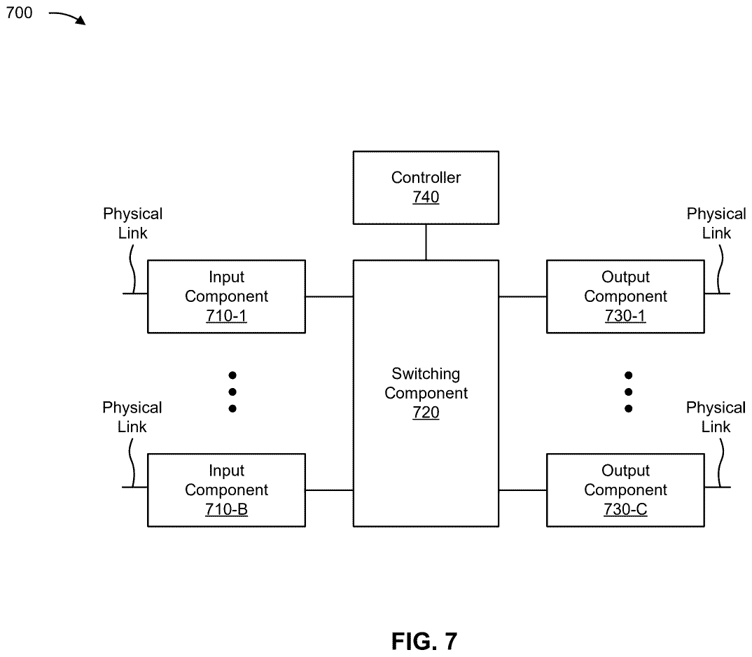

FIG. 7 is a diagram of example components of a device 700 associated with queue identifiers for transmission of network flows. Device 700 may correspond to node 520. In some implementations, node 520 may include one or more devices 700 and/or one or more components of device 700. As shown in FIG. 7, device 700 may include one or more input components 710-1 through 710-B (B≥1) (hereinafter referred to collectively as input components 710, and individually as input component 710), a switching component 720, one or more output components 730-1 through 730-C (C≥1) (hereinafter referred to collectively as output components 730, and individually as output component 730), and a controller 740.

Input component 710 may be one or more points of attachment for physical links and may be one or more points of entry for incoming traffic, such as packets. Input component 710 may process incoming traffic, such as by performing data link layer encapsulation or decapsulation. In some implementations, input component 710 may transmit and/or receive packets. In some implementations, input component 710 may include an input line card that includes one or more packet processing components (e.g., in the form of integrated circuits), such as one or more interface cards (IFCs), packet forwarding components, line card controller components, input ports, processors, memories, and/or input queues. In some implementations, device 700 may include one or more input components 710.

Switching component 720 may interconnect input components 710 with output components 730. In some implementations, switching component 720 may be implemented via one or more crossbars, via busses, and/or with shared memories. The shared memories may act as temporary buffers to store packets from input components 710 before the packets are eventually scheduled for delivery to output components 730. In some implementations, switching component 720 may enable input components 710, output components 730, and/or controller 740 to communicate with one another.

Output component 730 may store packets and may schedule packets for transmission on output physical links. Output component 730 may support data link layer encapsulation or decapsulation, and/or a variety of higher-level protocols. In some implementations, output component 730 may transmit packets and/or receive packets. In some implementations, output component 730 may include an output line card that includes one or more packet processing components (e.g., in the form of integrated circuits), such as one or more IFCs, packet forwarding components, line card controller components, output ports, processors, memories, and/or output queues. In some implementations, device 700 may include one or more output components 730. In some implementations, input component 710 and output component 730 may be implemented by the same set of components (e.g., and input/output component may be a combination of input component 710 and output component 730).

Controller 740 includes a processor in the form of, for example, a central processing unit (CPU), a GPU, an accelerated processing unit (APU), a microprocessor, a microcontroller, a digital signal processor (DSP), a field-programmable gate array (FPGA), an application-specific integrated circuit (ASIC), and/or another type of processor. The processor is implemented in hardware, firmware, or a combination of hardware and software. In some implementations, controller 740 may include one or more processors that can be programmed to perform a function.

In some implementations, controller 740 may include a RAM, a ROM, and/or another type of dynamic or static storage device (e.g., a flash memory, a magnetic memory, an optical memory, etc.) that stores information and/or instructions for use by controller 740.

In some implementations, controller 740 may communicate with other devices, networks, and/or systems connected to device 700 to exchange information regarding network topology. Controller 740 may create routing tables based on the network topology information, may create forwarding tables based on the routing tables, and may forward the forwarding tables to input components 710 and/or output components 730. Input components 710 and/or output components 730 may use the forwarding tables to perform route lookups for incoming and/or outgoing packets.

Controller 740 may perform one or more processes described herein. Controller 740 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with controller 740 from another computer-readable medium or from another device via a communication interface. When executed, software instructions stored in a memory and/or storage component associated with controller 740 may cause controller 740 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

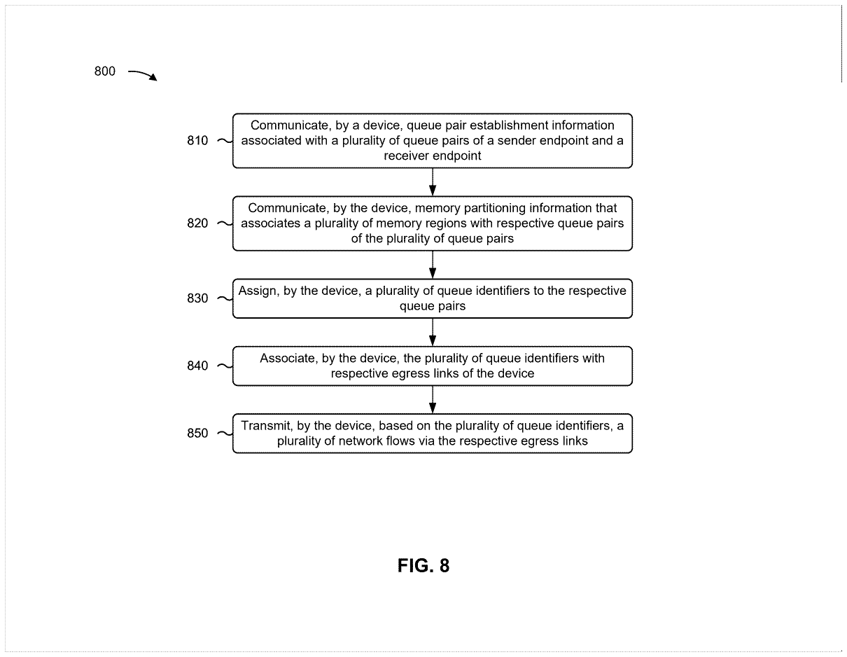

FIG. 8 is a flowchart of an example process 800 associated with queue identifiers for transmission of network flows. In some implementations, one or more process blocks of FIG. 8 are performed by a device (e.g., an ingress leaf node). In some implementations, one or more process blocks of FIG. 8 are performed by another device or a group of devices separate from or including the device, such as a peer device (e.g., peer device 510) and/or a node (e.g., node 520). Additionally, or alternatively, one or more process blocks of FIG. 8 may be performed by one or more components of device 600, such as processor 620, memory 630, input component 640, output component 650, and/or communication component 660, and/or one or more components of device 700, such as input component 710, switching component 720, output component 730, and/or controller 740.

As shown in FIG. 8, process 800 may include communicating queue pair establishment information associated with a plurality of queue pairs of a sender endpoint and a receiver endpoint (block 810). For example, the device may communicate queue pair establishment information associated with a plurality of queue pairs of a sender endpoint and a receiver endpoint, as described above.

As further shown in FIG. 8, process 800 may include communicating memory partitioning information that associates a plurality of memory region partitions with respective queue pairs of the plurality of queue pairs (block 820). For example, the device may communicate memory partitioning information that associates a plurality of memory region partitions with respective queue pairs of the plurality of queue pairs, as described above.

As further shown in FIG. 8, process 800 may include assigning a plurality of queue identifiers to the respective queue pairs (block 830). For example, the device may assign a plurality of queue identifiers to the respective queue pairs, as described above.

As further shown in FIG. 8, process 800 may include associating the plurality of queue identifiers with respective egress links of the device (block 840). For example, the device may associate the plurality of queue identifiers with respective egress links of the device, as described above.

As further shown in FIG. 8, process 800 may include transmitting based on the plurality of queue identifiers, a plurality of network flows via the respective egress links (block 850). For example, the device may transmit based on the plurality of queue identifiers, a plurality of network flows via the respective egress links, as described above.

Process 800 may include additional implementations, such as any single implementation or any combination of implementations described below and/or in connection with one or more other processes described elsewhere herein.

In a first implementation, the plurality of queue identifiers are a plurality of IP addresses.

In a second implementation, alone or in combination with the first implementation, associating the plurality of IP addresses with the respective egress links includes associating the plurality of IP addresses with the respective egress links using a routing configuration.

In a third implementation, alone or in combination with one or more of the first and second implementations, the plurality of queue identifiers are one or more of a plurality of flow labels or a plurality of source ports.

In a fourth implementation, alone or in combination with one or more of the first through third implementations, associating the one or more of the plurality of flow labels or the plurality of source ports with the respective egress links includes associating the one or more of the plurality of flow labels or the plurality of source ports with the respective egress links using an ACL.

In a fifth implementation, alone or in combination with one or more of the first through fourth implementations, the respective egress links comprise respective primary paths of the plurality of network flows.

In a sixth implementation, alone or in combination with one or more of the first through fifth implementations, process 800 includes detecting, by the device, a failure in a primary path of the respective primary paths, and transmitting, by the device, a network flow of the plurality of network flows associated with the primary path via one or more backup paths.

In a seventh implementation, alone or in combination with one or more of the first through sixth implementations, the plurality of network flows is a plurality of RDMA network flows.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, traffic or content may include a set of packets. A packet may refer to a communication structure for communicating information, such as a protocol data unit (PDU), a service data unit (SDU), a network packet, a datagram, a segment, a message, a block, a frame (e.g., an Ethernet frame), a portion of any of the above, and/or another type of formatted or unformatted unit of data capable of being transmitted via a network.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors to: perform X; perform Y; and perform Z,” that claim should be interpreted to mean “one or more processors to perform X; one or more (possibly different) processors to perform Y; and one or more (also possibly different) processors to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
communicating, by a device, queue pair establishment information associated with a plurality of queue pairs of a sender endpoint and a receiver endpoint;
communicating, by the device, memory partitioning information that associates a plurality of memory region partitions with respective queue pairs of the plurality of queue pairs;
assigning, by the device, a plurality of queue identifiers to the respective queue pairs;
associating, by the device, the plurality of queue identifiers with respective egress links of the device; and
transmitting, by the device, based on the plurality of queue identifiers, a plurality of network flows via the respective egress links.

2. The method of claim 1, wherein the plurality of queue identifiers are a plurality of internet protocol (IP) addresses.

3. The method of claim 2, wherein associating the plurality of IP addresses with the respective egress links includes associating the plurality of IP addresses with the respective egress links using a routing configuration.

4. The method of claim 1, wherein the plurality of queue identifiers are one or more of a plurality of flow labels or a plurality of source ports.

5. The method of claim 4, wherein associating the one or more of the plurality of flow labels or the plurality of source ports with the respective egress links includes associating the one or more of the plurality of flow labels or the plurality of source ports with the respective egress links using an access control list (ACL).

6. The method of claim 1, wherein the respective egress links comprise respective primary paths of the plurality of network flows.

7. The method of claim 6, further comprising:
detecting, by the device, a failure in a primary path of the respective primary paths; and
transmitting, by the device, a network flow of the plurality of network flows associated with the primary path via one or more backup paths.

8. The method of claim 1, wherein the plurality of network flows is a plurality of remote direct memory access (RDMA) network flows.

9. A device, comprising:
one or more memories; and
one or more processors to:
communicate queue pair establishment information associated with a plurality of queue pairs of a sender endpoint and a receiver endpoint;
communicate memory partitioning information that associates a plurality of memory region partitions with respective queue pairs of the plurality of queue pairs;
assign a plurality of queue identifiers to the respective queue pairs;
associate the plurality of queue identifiers with respective egress links of the device; and
transmit, based on the plurality of queue identifiers, a plurality of remote direct memory access (RDMA) network flows via the respective egress links.

10. The device of claim 9, wherein the plurality of queue identifiers are a plurality of internet protocol (IP) addresses.

11. The device of claim 10, wherein the one or more processors, to associate the plurality of IP addresses with the respective egress links, are to associate the plurality of IP addresses with the respective egress links using a routing configuration.

12. The device of claim 9, wherein the plurality of queue identifiers are one or more of a plurality of flow labels or a plurality of source ports.

13. The device of claim 12, wherein the one or more processors, to associate the one or more of the plurality of flow labels or the plurality of source ports with the respective egress links, are to associate the one or more of the plurality of flow labels or the plurality of source ports with the respective egress links using an access control list (ACL).

14. The device of claim 9, wherein the respective egress links correspond to respective primary paths.

15. The device of claim 14, wherein the one or more processors are further to:
detect a failure in a primary path of the respective primary paths; and
transmit a network flow of the plurality of RDMA network flows associated with the primary path via one or more backup paths.

16. A non-transitory computer-readable medium storing a set of instructions, the set of instructions comprising:
one or more instructions that, when executed by one or more processors of a device, cause the device to:
communicate queue pair establishment information associated with a plurality of queue pairs of a sender endpoint and a receiver endpoint;
communicate memory partitioning information that associates a plurality of memory region partitions with respective queue pairs of the plurality of queue pairs;
assign a plurality of internet protocol (IP) addresses to the respective queue pairs;
associate the plurality of IP addresses with respective egress links of the device; and
transmit, based on the plurality of IP addresses, a plurality of network flows via the respective egress links.

17. The non-transitory computer-readable medium of claim 16, wherein the one or more instructions, that cause the device to associate the plurality of IP addresses with the respective egress links, cause the device to associate the plurality of IP addresses with the respective egress links using a routing configuration.

18. The non-transitory computer-readable medium of claim 16, wherein the respective egress links correspond to respective primary paths.

19. The non-transitory computer-readable medium of claim 18, wherein the one or more instructions further cause the device to:
detect a failure in a primary path of the respective primary paths; and
transmit a network flow of the plurality of network flows associated with the primary path via one or more backup paths.

20. The non-transitory computer-readable medium of claim 16, wherein the plurality of network flows is a plurality of remote direct memory access (RDMA) network flows.
